(19) United States
(12) Patent Application Publication
(10) Pub. No.: US 2014/0076268 A1
(43) Pub. Date: Mar. 20, 2014

(54) ENGINE

(71) Applicant: Fuji Jukogyo Kabushiki Kaisha, Tokyo (JP)

(72) Inventor: Akira FURUYA, Tokyo (JP)

(73) Assignee: Fuji Jukogyo Kabushiki Kaisha, Tokyo (JP)

(21) Appl. No.: 14/028,325

(22) Filed: Sep. 16, 2013

(30) Foreign Application Priority Data
Sep. 20, 2012 (JP) 2012-206904

(51) Int. Cl. F02B 75/32

(52) U.S. Cl. CPC F02B 75/32
USPC 123/197.4

(57) ABSTRACT

An engine includes: a cylinder; a first bearing that is at least partially integrally formed with the cylinder and configured to rotatably support a first shaft of a crankshaft; a second bearing that is at least partially integrally formed with the cylinder and configured to rotatably support a second shaft of the crankshaft; and a first crankcase member and a second crankcase member that include a resin-based material, and respectively constitute part and remaining part of a crankcase that houses the crankshaft. A connecting portion between the first crankcase member and the second crankcase member is continuously connected along substantially an entire length by at least one of fitting, bonding, and welding.

### CROSS-REFERENCE TO RELATED APPLICATIONS

The present application claims priority from Japanese Patent Application No. 2012-206904 filed on Sep. 20, 2012, the entire contents of which are hereby incorporated by reference.

### BACKGROUND

1. Related Field

The present invention relates to an engine, and particularly to an engine achieving a simplified structure, and weight and cost reduction.

2. Description of the Related Art

A general purpose engine is mounted as a power source on equipment for industrial use or gardening work, for example. For the general purpose engine, there is a high demand for reduction in cost and weight, and thus various approaches have been proposed to achieve a simplified structure and weight reduction. Related technology for simplified engine structure includes, for example, Japanese Unexamined Patent Application Publication (JP-A) No. 60-27762 which describes that part of a main bearing is integrally formed with a cylinder in an engine for outboard motors, the main bearing being configured to rotatably support the shaft (journal portion) of a crankshaft. JP-A No. 7-310589 describes that in a two-stroke engine, an engine block is assembled with a cylinder, a piston, a conn-rod, a crankshaft, a main bearing, and a crankcase is formed by performing injection molding of a resin material on the engine block.

For particular purpose out of general purpose engines, for example, for gardening there is a significantly high demand from users for low cost engines. However, in reality, when an engine has a failure, the engine is not overhauled but is replaced by a new one and is processed for recycling. Adopting a structure which allows an engine to be overhauled by mounting each component of the engine using a bolt or the like leads a complicated structure and an increase in weight and cost, and thus is not desirable. If a component such as a crankcase which receives a relatively small stress and is large in size can be changed from a cast component made of e.g. aluminum-based alloy to a resin molded component, a significant reduction in weight and cost, and reduction in noise such as radiated noise can be achieved, which is preferable. JP-A No. 7-310589 describes use of a crankcase made of resin, however, a specific manufacturing method and shape of the crankcase is almost not described. Disclosed in JP-A No. 7-310589 is a technology related to a two-stroke engine in which a crankcase is relatively small and intensity is easily achieved, and it is not possible to manufacture a resin-made crankcase of a four-stroke engine based on the disclosed content, the four-stroke engine being the present mainstream general purpose engine.

### SUMMARY OF THE INVENTION

In view of the above-mentioned problem, it is an object of the present invention to provide an engine which achieves a simplified structure and weight and cost reduction.

A first aspect of the present invention provides an engine including: a cylinder; a first bearing that is at least partially integrally formed with the cylinder and configured to rotatably support a first shaft of a crankshaft; a second bearing that is at least partially integrally formed with the cylinder and configured to rotatably support a second shaft of the crankshaft; and a first crankcase member and a second crankcase member that include a resin-based material, and respectively constitute part and remaining part of a crankcase housing the crankshaft. A connecting portion between the first crankcase member and the second crankcase member is continuously connected along substantially an entire length by at least one of fitting, bonding, and welding. According to this aspect, the crankcase can be a resin molded component rather than a typical metal cast component, and thus a significant decrease in weight and reduction in cost can be achieved. Furthermore, radiated noise from the crankcase can be also reduced. The first crankcase member and the second crankcase member are connected to each other by at least one of fitting, bonding, and welding, and thus a fastener such as a bolt does not need to be provided in order to connect these members. Furthermore, an assembly space for screwing bolts, and a work space for using tools or allowing a worker's hands do not need to be considered, and thus reduction in weight, a simplified structure, an improvement in design flexibility, and a simplified manufacturing process can be achieved. In addition, the first crankcase member and the second crankcase member are continuously connected along substantially an entire length, and thus in contrast to the case where a partial connection is made therebetween using e.g. a bolt, a high strength of connection, rigidity of the crankcase, and a favorable sealing function for reliably sealing against lubricating oil or blow-by gas leakage can be obtained.

Preferably, a protrusion is formed in the connecting portion of the first crankcase member to be connected with the second crankcase member, and a groove is formed in the connecting portion of the second crankcase member to be connected with the first crankcase member, the protrusion being inserted and fitted into the groove. Accordingly, the first crankcase member and the second crankcase member can be easily and firmly fixed to each other by fitting the protrusion to the groove. In addition, it is also easy to reliably seal the connecting portion by previously filling the groove with an adhesive or a sealing agent.

Preferably, the crankshaft is divided into the first crankcase member and the second crankcase member in an axial direction of the crankshaft, the first crankcase member has a first opening on which the first bearing is mounted, the second crankcase member has a second opening on which the second bearing is mounted, and a connecting portion between a circumferential edge of the first opening and the first bearing, and a connecting portion between a circumferential edge of the second opening and the second bearing are each continuously connected along substantially an entire length by at least one of fitting, bonding, and welding. Accordingly, the above connecting portions can be easily and firmly fixed to each other, and a favorable sealing function can be obtained.

Preferably, at least either one of the first crankcase member and the second crankcase member is integrally formed and has a cylinder cover for covering a circumference of the cylinder and guiding cooling air to be introduced to an inside. Accordingly, the cooling efficiency of the cylinder can be increased and emission of radiated noise from the cylinder to the outside can be reduced, and thus further reduction of noise can be achieved.

Preferably, part of a power transmission member housing is integrally formed in at least one of the first crankcase member and the second crankcase member, the power transmission member housing being configured to house a power transmission member which transmits power from the crankshaft to a camshaft. Accordingly, reduction in the number of components and weight and a simplified assembly process can be achieved by integrating part of the power transmission member housing with the crankcase member. In contrast to the case where the power transmission member housing is formed in part of the cylinder block, the entire circumference of the cylinder can be favorably cooled.

Preferably, a remaining part of the power transmission member housing is integrally formed with part of a blower housing which is fixed to the crankshaft and houses a blower fan for generating cooling air when in rotation. Further preferably, the cylinder and a cylinder head are integrally formed, the cylinder head having inlet and exhaust ports and being provided at an end of the cylinder that is opposite to an end of the crankshaft of the cylinder. Accordingly, a further simplified structure and reduction in weight and the number of components can be achieved.

### BRIEF DESCRIPTION OF THE DRAWINGS

FIG. 1 is a cross-sectional view of an engine according to an embodiment of the present invention, the view being taken along the plane including a crank axis and a cylinder axis;

FIG. 2 is a top view of a cylinder block of the engine in FIG. 1;

FIG. 3 is a side view of the engine as seen in the direction of arrow III in FIG. 2;

FIG. 4 is a side view of the engine as seen in the direction of arrow IV in FIG. 2;

FIG. 5 is a side view of the engine as seen in the direction of arrow V in FIG. 3;

FIG. 6 is a cross-sectional view of the engine taken along line VI-VI of FIG. 3;

FIG. 7 is a cross-sectional view of the engine taken along line VII-VII of FIG. 2;

FIG. 8 is a cross-sectional view of the engine taken along line VIII-VIII of FIG. 1;

FIG. 9 is a cross-sectional view of the engine taken along line IX-IX of FIG. 1;

FIG. 10 is a top view (in the direction of the axis of a crankshaft) of the engine according to the embodiment after an upper blower housing, a recoil cover, and a recoil starter are removed from the engine;

FIG. 11 is a view of the engine taken along line XI-XI of FIG. 10;

FIG. 12 is a top view of the engine according to the embodiment immediately after the crankshaft is mounted on a cylinder block;

FIG. 13 is a schematic cross-sectional view of the engine of FIG. 12 taken along a plane which is perpendicular to the axial direction of the cylinder and includes the axis of the crankshaft;

FIG. 14 is a top view of the engine according to the embodiment after a lower crankcase is mounted;

FIG. 15 is a schematic cross-sectional view of the engine of FIG. 14 taken along a plane which is perpendicular to the axial direction of the cylinder and includes the axis of the crankshaft;

FIG. 16 is a top view of the engine according to the embodiment after an upper crankcase is mounted;

FIG. 17 is a schematic cross-sectional view of the engine of FIG. 16 taken along a plane which is perpendicular to the axial direction of the cylinder and includes the axis of the crankshaft;

FIG. 18 is a top view of the engine according to the embodiment after a lower blower housing is mounted;

FIG. 19 is a schematic cross-sectional view of the engine of FIG. 18 taken along a plane which is perpendicular to the axial direction of the cylinder and includes the axis of the crankshaft;

FIG. 20 is a top view of the completely assembled engine according to the embodiment; and

FIG. 21 is a schematic cross-sectional view of the engine of FIG. 20 taken along a plane which is perpendicular to the axial direction of the cylinder and includes the axis of the crankshaft.

### DETAILED DESCRIPTION

The present invention achieves the object, which is to provide an engine having a simplified structure and reduced weight and cost, by the following manner. Part of the main bearing is formed integrally with the cylinder block, the crankcase is formed by resin molded components divided in two halves, and the resin molded components are connected to each other along the entire connecting portion by fitting or bonding.

### Example

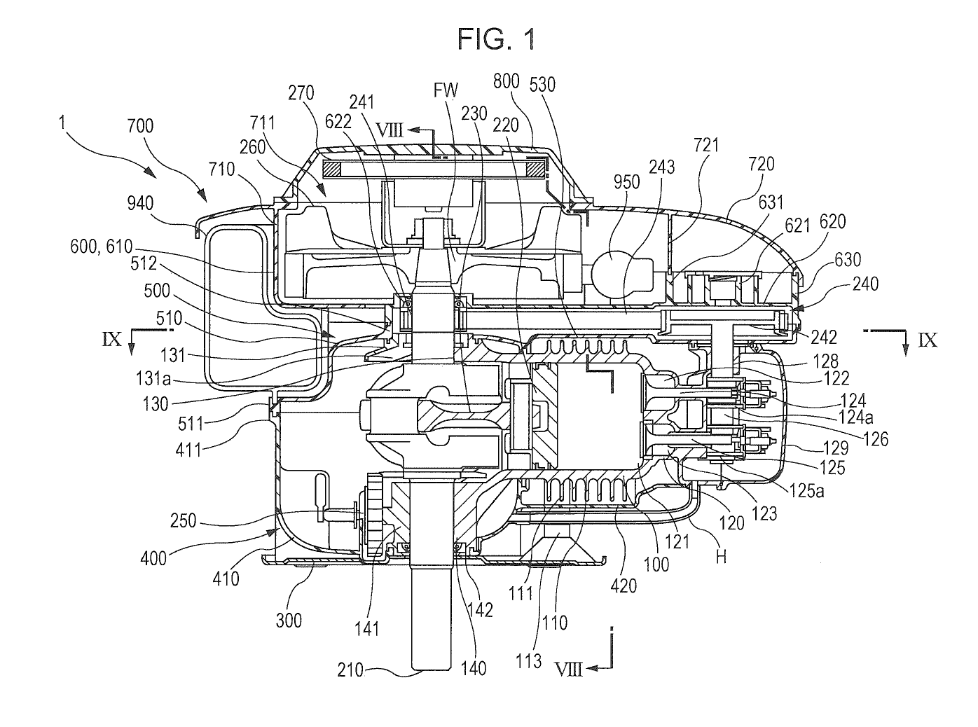

Hereinafter, an engine according to an example of the present invention will be described. The engine according to the example is a general purpose single-cylinder four-stroke OHC gasoline engine in which the rotation axis of a crankshaft is arranged in a substantially vertical direction, for instance. The engine according to the example is mounted as a power source, for instance, on gardening equipment such as a lawn mower, a power generator, or other various equipment. FIG. 1 is a cross-sectional view of the engine according to the example, the view being taken along the plane including a crank axis and a cylinder axis.

An engine 1 includes a cylinder block 100, a crankshaft 210, a piston 220, a conn-rod 230, a valve drive mechanism 240, a governor mechanism 250, a blower fan 260, a recoil starter 270, a base plate 300, a lower crankcase 400, an upper crankcase 500, a lower blower housing 600, an upper blower housing 700, a recoil cover 800, an air cleaner 910, a carburetor 920, a muffler 930, a fuel tank 940, an ignition device 950, and a drive control mechanism 960. Hereinafter, each component will be described in detail one by one.

First, a cylinder block 100 will be described.

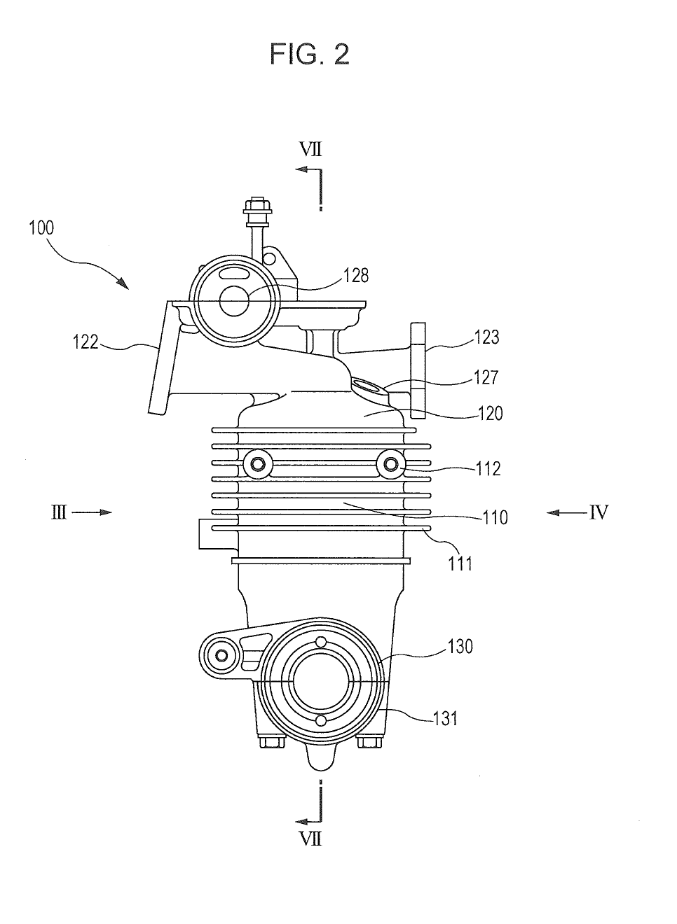

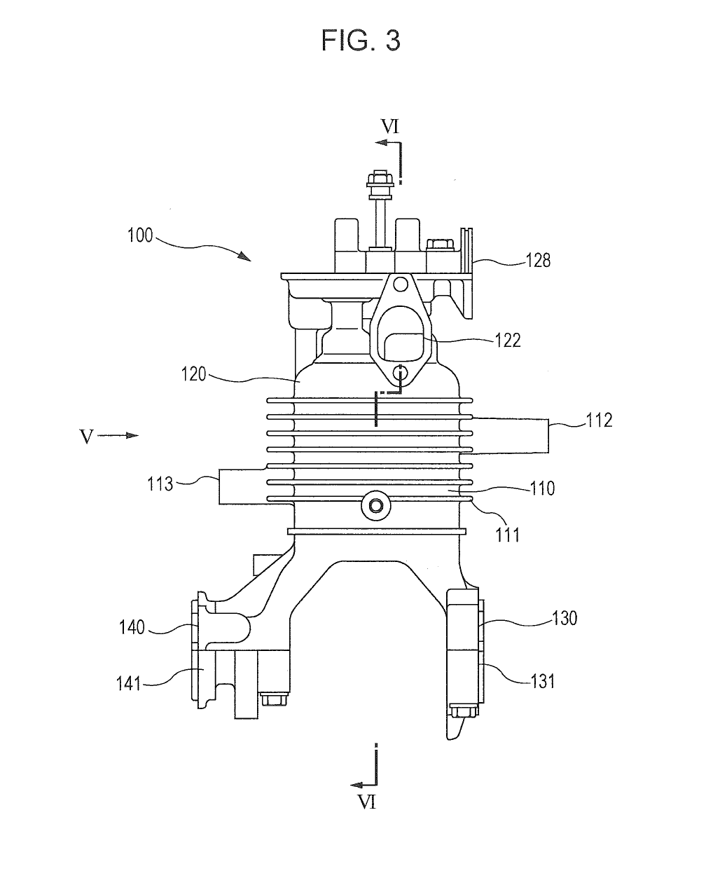

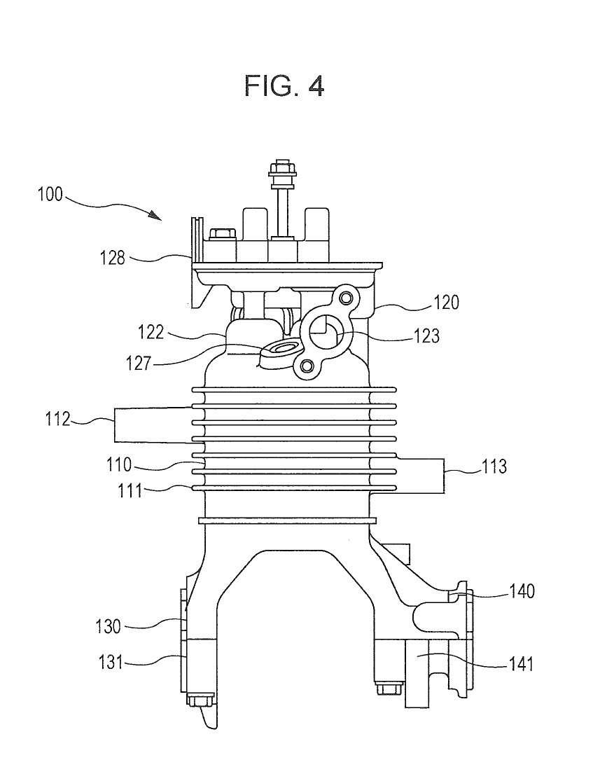

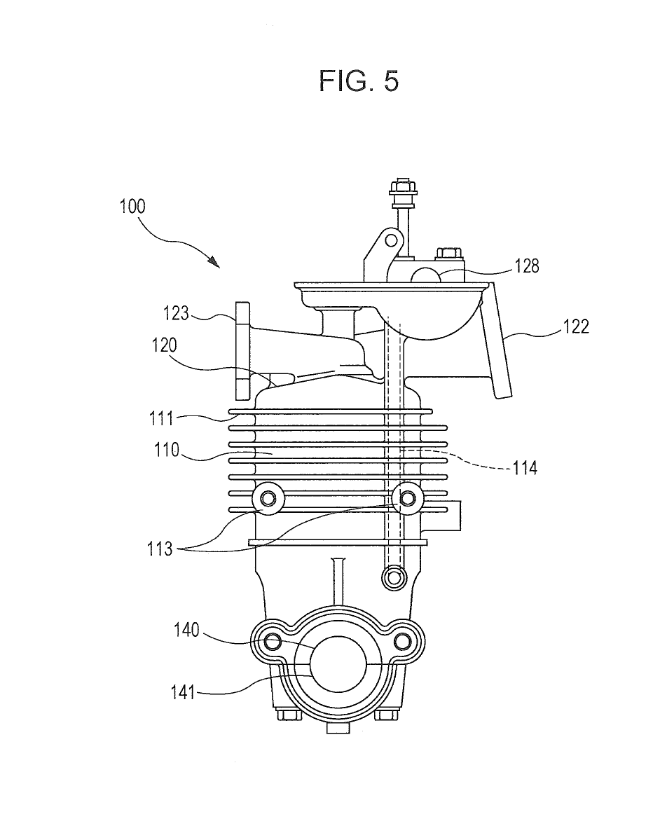

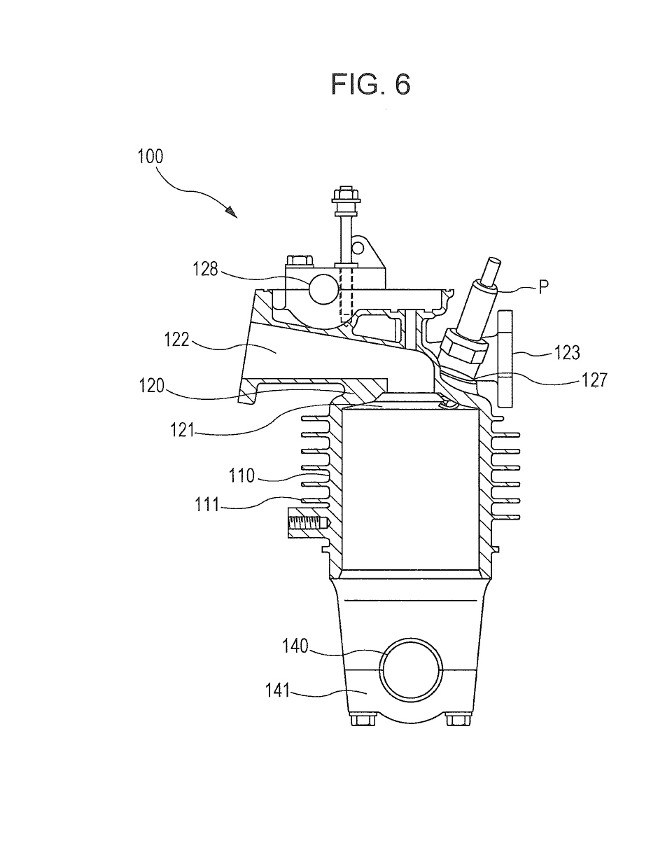

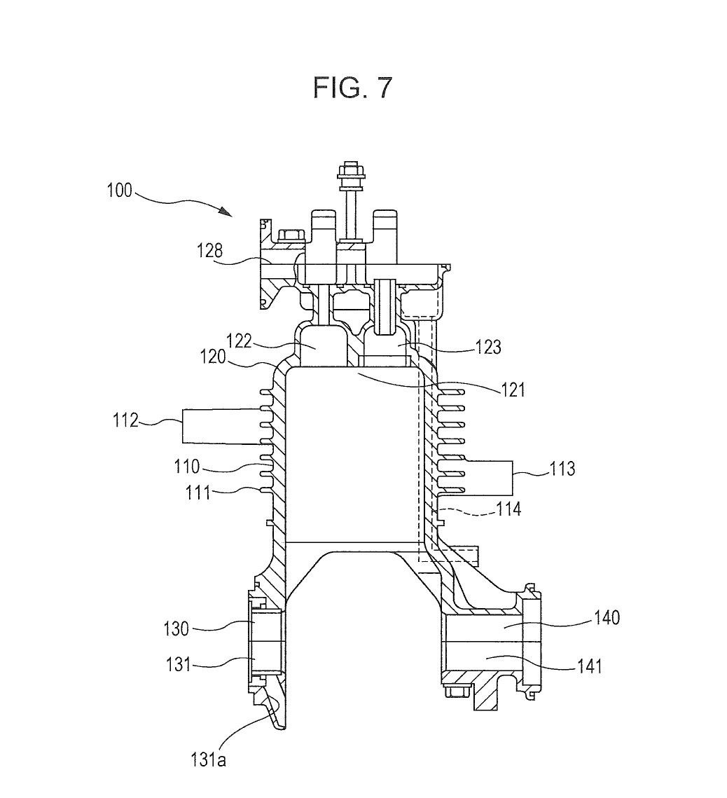

FIG. 2 is a top view of the cylinder block 100.
FIG. 3 is a side view of the engine as seen in the direction of arrow III in FIG. 2 (a view seen from an inlet port).
FIG. 4 is a side view of the engine as seen in the direction of arrow IV in FIG. 2 (a view seen from an exhaust port).
FIG. 5 is a view of the engine as seen in the direction of arrow V in FIG. 3 (a view seen from below).
FIG. 6 is a cross-sectional view of the engine taken along line VI-VI of FIG. 3.
FIG. 7 is a cross-sectional view of the engine taken along line VII-VII of FIG. 2.

The cylinder block 100 is obtained by integrally forming the main components which are a cylinder 110, a cylinder head 120, an upper main bearing 130, and a lower main bearing 140. The main components of the cylinder block 100 is formed by casting, for instance, an aluminum-based alloy and applying a predetermined machining process to the casted alloy.

The cylinder 110 is a cylindrical component in which a piston is inserted and moves back and forth. The cylinder 110 is formed as a linerless plated cylinder so as to reduce the number of parts of the cylinder 110. In the cylinder 110, sub-components including a fin 111, an ignition device mounting portion 112, and a base plate mounting portion 113 are formed. The fin 111 is a planar component which is formed as a collar shaped projection from the outer circumferential surface of the cylinder 110. A plurality of the fins 111 are arranged in the axial direction of the cylinder 110 with an interval between adjacent fins 111.

The ignition device mounting portion 112 is a base for fixing the ignition device 950 to the cylinder 110. The ignition device mounting portion 112 is formed projecting upward from the cylinder 110. The base plate mounting portion 113 is a base for mounting the base plate 300 on the cylinder 110. The base plate mounting portion 113 is formed projecting downward from the cylinder 110.

The cylinder head 120 is disposed at the end of the cylinder 110 that is opposite to the crankshaft 210 of the cylinder 110. The cylinder head 120 includes a combustion chamber 121, an inlet port 122, an exhaust port 123, an inlet valve 124, an exhaust valve 125, a camshaft 126, a plug hole 127, a cam bearing 128, and a head cover 129.

The combustion chamber 121 is a chamber which forms a combustion space for a fuel-air mixture in cooperation with the crown surface of the piston 220 and the inner circumferential surface of the cylinder 110. The combustion chamber 121 is a recess which is formed in the inner surface of the cylinder head 120 radially inward of the cylinder 110. The inlet port 122 is a passage for introducing a fuel-air mixture into the combustion chamber 121, the fuel-air mixture being created by the carburetor 920. The inlet of the inlet port 122 opens in a laterally outward direction of the cylinder head 120. The exhaust port 123 is a passage for discharging burnt gas from the inside of the combustion chamber 121 to the muffler 930. The outlet of the exhaust port 123 opens in the laterally outward direction of the cylinder head 120 that is opposite to the laterally outward direction through the inlet of the inlet port 122 of the cylinder head 120.

The inlet valve 124 and the exhaust valve 125 are movable valves for opening/closing the inlet port 122 and the exhaust port 123 at a predetermined valve timing. The inlet valve 124 and the exhaust valve 125 each include a valve stem that is a slidable shaft inserted into an opening which is formed in the cylinder head 120, and an umbrella-shaped valve body which is formed at the end of the valve stem. The inlet valve 124 and the exhaust valve 125 are arranged in parallel, so that the respective valve stems are horizontally disposed and the inlet valve 124 is located higher than the exhaust valve 125. The inlet valve 124 and the exhaust valve 125 are respectively provided with valve springs 124a, 125a that urge in directions for closing the respective values, and the values open when being pressed by the camshaft 126 via a rocker arm.

The camshaft 126 rotates at a rotational speed half the rotational speed of the crankshaft 210, and is provided with a cam portion (sliding surface portion) which opens/closes the inlet valve 124 and the exhaust valve 125 at a predetermined valve timing. The camshaft 126 pushes the ends of valve stem shafts of the inlet valve 124 and the exhaust valve 125 so as to drive the valves 124, 125 via the rocker arm rockably supported by the cylinder head 120. A cam sprocket 242, around which a timing belt 243 is wound, is mounted on the upper end of the camshaft 126.

The plug hole 127 is a screw hole into which a spark plug P for igniting a fuel-air mixture in the combustion chamber 121 is inserted, and is disposed adjacent to the inlet port 122 and the exhaust port 123. The cam bearing 128 is a bearing which rotatably supports the camshaft 126. The cam bearing 128 is a metal bearing which forms a lubricating oil film on the surface of a metal and supports the shaft of the camshaft 126. Half of the cam bearing 128 is formed in the cylinder head 120 by a machining process, and the remaining half is formed in a rocker support member which is a separate body. The head cover 129 is a lid-shaped member which is covered at the end of the cylinder head 120 that is opposite to the crankshaft 210 of the cylinder head 120, and covers the components including the camshaft 126 and the rocker arm. The head cover 129 is integrally formed by injection molding using a resin-based material.

The upper main bearing 130 and the lower main bearing 140 are bearings which rotatably support respective journal portions (shaft) which are formed at upper and lower positions of the crankshaft 210. The upper main bearing 130 and the lower main bearing 140 are disposed at the ends of respective arm-shaped portions projecting from the end of the cylinder 110 near the crankshaft 210. The upper main bearing 130 and the lower main bearing 140 are metal bearings what are commonly called direct metal, and which each form a lubricating oil film on the surface of a machine processed metal, and supports the shaft. Half of the upper main bearing 130 and the lower main bearing 140 are formed by applying a machining process to a portion which is integrally formed with the cylinder block 100, and the remaining half is formed by applying a machining process to bearing caps 131,141 which are separate bodies.

At the bearing cap 131 of the upper main bearing 130, a passage 131a is formed which introduces a gas such as a blow-by gas containing an oil mist that flows inside the crankcase, and which guides the gas into a sliding portion with the crankshaft 210 and further introduces the oil and the blow-by gas into the below-described belt housing. The inlet of the passage 131a opens inwardly of the crankcase, and the outlet thereof opens at a bearing which slides on the crankshaft 210. The oil mist guided into the sliding portion from the passage 131a lubricates the sliding portion, and is introduced into the belt housing through a groove which is formed in at least one of the bearing and the shaft. The below-described governor mechanism 250 is mounted on the bearing cap 141 of the lower main bearing 140. An oil seal 142 which prevents oil leakage downward from the crankcase is disposed at a lower position of the lower main bearing 140.

The crankshaft 210 is an output shaft of the engine 1, and its axis is arranged in a substantially vertical direction. A crank pin off-centered from the rotational axis and a crank arm which supports the crank pin are formed in the middle of the crankshaft 210. A balance weight is integrally formed with the crank arm.

A recoil starter 270, a blower fan 260, an oil seal 622, and a crank sprocket 241 are disposed in this order from the upper position above the crankshaft 210. The crank sprocket 241 is mounted immediately above the upper main bearing 130. The lower part of the crankshaft 210 projects downward from the base plate 300 as the output shaft of the engine 1, and a device to be driven is mounted on the lower part.

The piston 220 is a member which is inserted into the cylinder 110 of the cylinder block 100 and moves back and forth in the cylinder 110 so as to transmit the pressure of combustion gas to the crankshaft 210 via the conn-rod 230. A plurality of ring grooves are formed spaced apart in the axial direction on the outer circumferential surface of the piston 220, and an oil ring and a piston ring are fitted into the ring grooves. The conn-rod (connecting rod) 230 is a member which is rockable with respect to the crankpin of the crankshaft 210 and a piston pin inserted into the piston 220, and which transmits power between the crankpin and the piston pin.

The valve drive mechanism 240 transmits power from the crankshaft 210 to the camshaft 126 of the cylinder head 120 so as to drive the inlet valve 124 and the exhaust valve 125. The valve drive mechanism 240 includes the crank sprocket 241, the cam sprocket 242, and the timing belt 243. The crank sprocket 241 is mounted above the crankshaft 210. The cam sprocket 242 is mounted above the camshaft 126, and has twice as many teeth as the crank sprocket 241. The timing belt 243 is a cogged belt having an oil resistance, which is wound around the crank sprocket 241 and the cam sprocket 242. With the above-described configuration, the camshaft 126 rotates synchronously with the crankshaft 210 at a rotational speed half the rotational speed of the crankshaft 210.

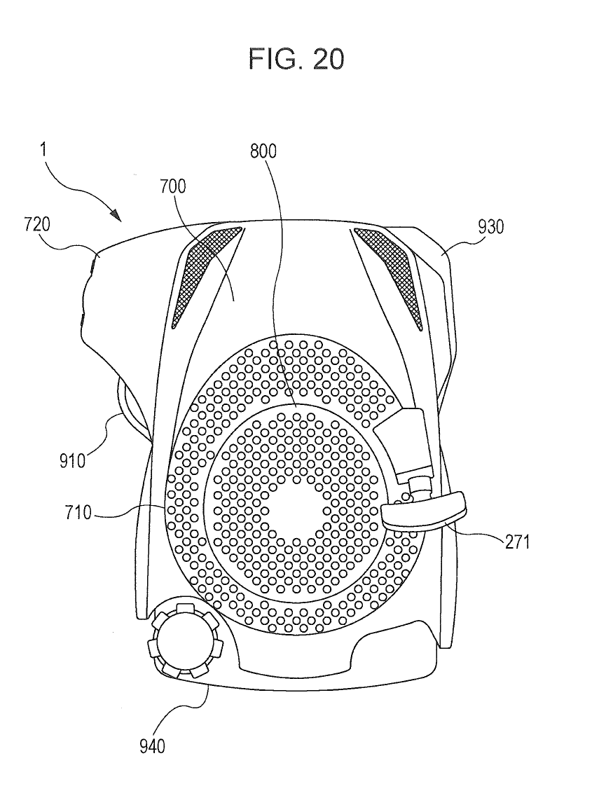

The governor mechanism 250 is a mechanism which controls the number of revolutions of the engine 1 using a centrifugal governor. The blower fan 260 is fixed to an upper end of the crankshaft 210 to generate an air flow for cooling the engine 1 during rotation. The blower fan 260 is made of resin and mounted on a flywheel FW. In the example, the blower fan 260 is a component separated from the flywheel FW, however, the blower fan 260 may be integrated with the flywheel FW. The recoil starter 270 causes forced rotation of the crankshaft 210 to start the engine 1 by a user's operation of pulling a recoil knob 271 (see FIG. 20).

The base plate 300 is a plate-shaped member which is disposed at a lower position of the engine 1 and arranged in a substantially horizontal direction. The base plate 300 is a component which serves as the base for mounting the engine 1 on a device to be driven. The base plate 300 is a panel which is formed by stamping a steel plate, for instance, and which is provided with projections and recesses as needed in order to achieve rigidity.

The lower crankcase 400 and the upper crankcase 500 are members which jointly form the crankcase divided in two halves. The lower crankcase 400 and the upper crankcase 500 are integrally formed by injection molding respective resin-based materials.

The lower crankcase 400 is a member which constitutes the lower half of the crankcase. The lower crankcase 400 includes a main body 410 and a cylinder cover 420. The main body 410 is provided surrounding components including the crankshaft 210 and the governor mechanism 250, in the area below the axis of the cylinder 110.

The main body 410 is formed in a container shape which opens upward, and serves as an oil pan for storing lubricating oil for the engine 1. An upper edge 411 of the main body 410 is provided with a groove to be inserted into a protrusion along substantially an entire length, the protrusion being formed at a lower edge 511 of a main body 510 of the upper crankcase 500.

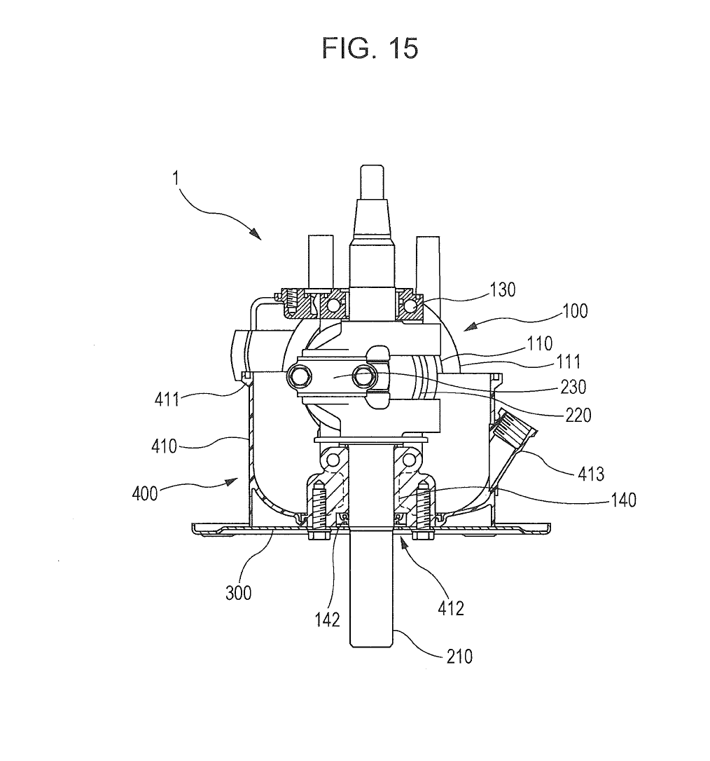

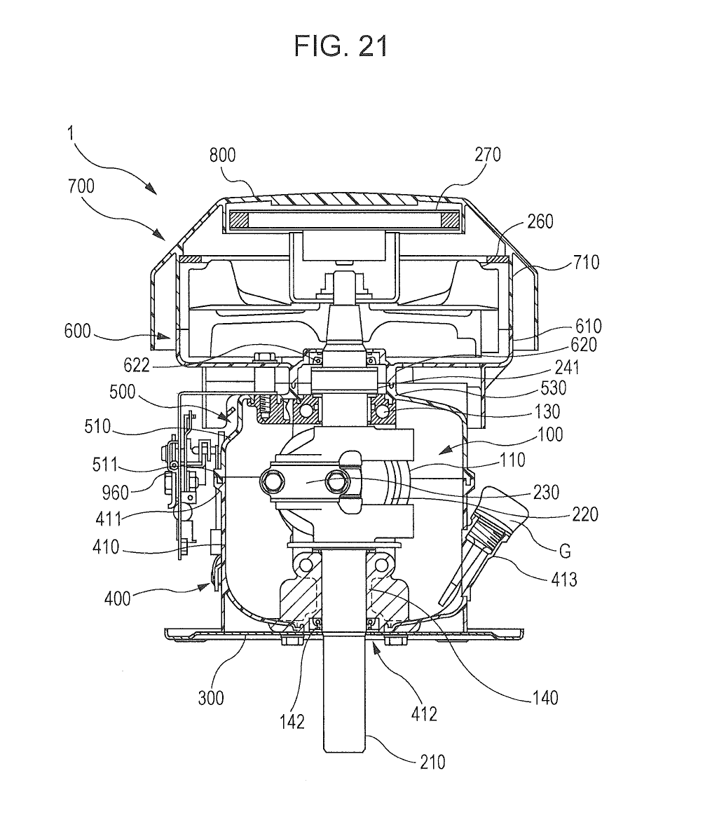

An opening 412 (see FIG. 15) into which the lower end of the lower main bearing 140 is inserted is formed at the lower end of the main body 410. A circular protrusion projecting upward is formed along the circumference of the opening 412. The protrusion is inserted into and fitted to the groove which is formed in the lower main bearing 140. In addition, the main body 410 is provided with a gage mounting portion 413 on which an oil level gauge G (see FIG. 21) is detachably mounted.

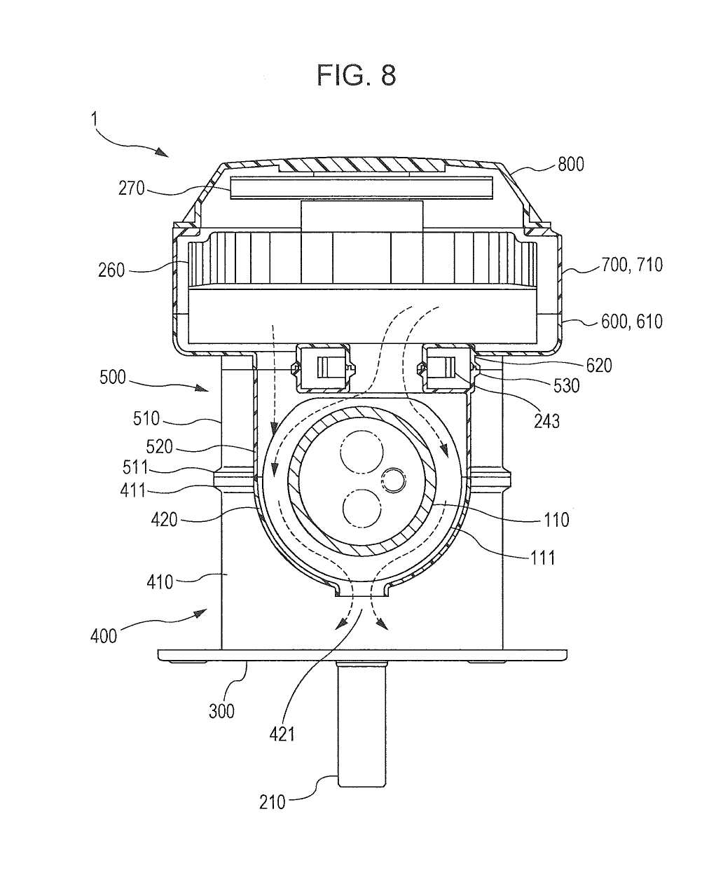

The cylinder cover 420 substantially covers the lower half of the cylinder 110, and guides the cooling air flow generated by the blower fan 260. FIG. 8 is a cross-sectional view of the engine 1 taken along line VIII-VIII of FIG. 1. The cylinder cover 420 and a cylinder cover 520 of the upper crankcase 500 jointly cover the circumference of the cylinder 110 so as to guide the cooling air flow generated by the blower fan 260, and block the noise radiated from the cylinder 110. As illustrated in FIG. 8, the cylinder cover 420 has a cross section which is substantially an upwardly open semicircle as seen in the cylinder axial direction. An opening 421 for discharging cooling air is formed at the lower end of the cylinder cover 420.

The upper crankcase 500 is a member which constitutes the upper half of the crankcase. The upper crankcase 500 includes the main body 510, the cylinder cover 520, and a belt housing 530. The main body 510 is provided surrounding components including the crankshaft 210, in the area above the axis of the cylinder 110. The main body 510 is formed in a container shape which opens downward. The lower edge 511 of the main body 510 is provided with a groove to be inserted into a protrusion along substantially an entire length, the protrusion being formed at the upper edge 411 of the main body 410 of the lower crankcase 400.

The lower crankcase 400 and the upper crankcase 500 are connected to each other by filling the groove at the lower crankcase 400 with adhesive having a sealing function and fitting the protrusion at the upper crankcase 500 into the groove. In the above process, adhesive overflowing from the groove spreads over substantially the entire connecting surface between the upper edge 411 of the lower crankcase 400 and the lower edge 511 of the upper crankcase 500 so as to bond the upper edge 411 and the lower edge 511 together. In order to ensure that some adhesive remains in the groove, the volume of the groove is made greater than the volume of the protrusion.

An opening 512, into which the upper end of the upper main bearing 130 is inserted, is formed at the upper end of the main body 510. A circular protrusion projecting downward is formed along the circumference of the opening 512. The protrusion is inserted into and fitted to the groove which is formed in the upper main bearing 130. Grooves are formed in the main body 410 of the lower crankcase 400 and the main body 510 of the upper crankcase 500, the protrusion extending in the circumferential direction on the outer circumferential surface of the cylinder 110 being inserted into the groove. Connection and sealing between the outer circumferential surface of the cylinder 110 and the crankcase are made by filling the grooves with adhesive and inserting the protrusion at the cylinder 110 into the grooves.

The cylinder cover 520 substantially covers the upper half of the cylinder 110, and guides the cooling air flow generated by the blower fan 260. As illustrated in FIG. 8, the cylinder cover 520 has a planar wall surface which is formed in the axial direction of the cylinder 110 and in substantially the upper direction. The lower end of the cylinder cover 520 is connected to the upper end of the cylinder cover 420 of the lower crankcase 400. The upper end of the cylinder cover 520 is connected to the lower end of the lower blower housing 600.

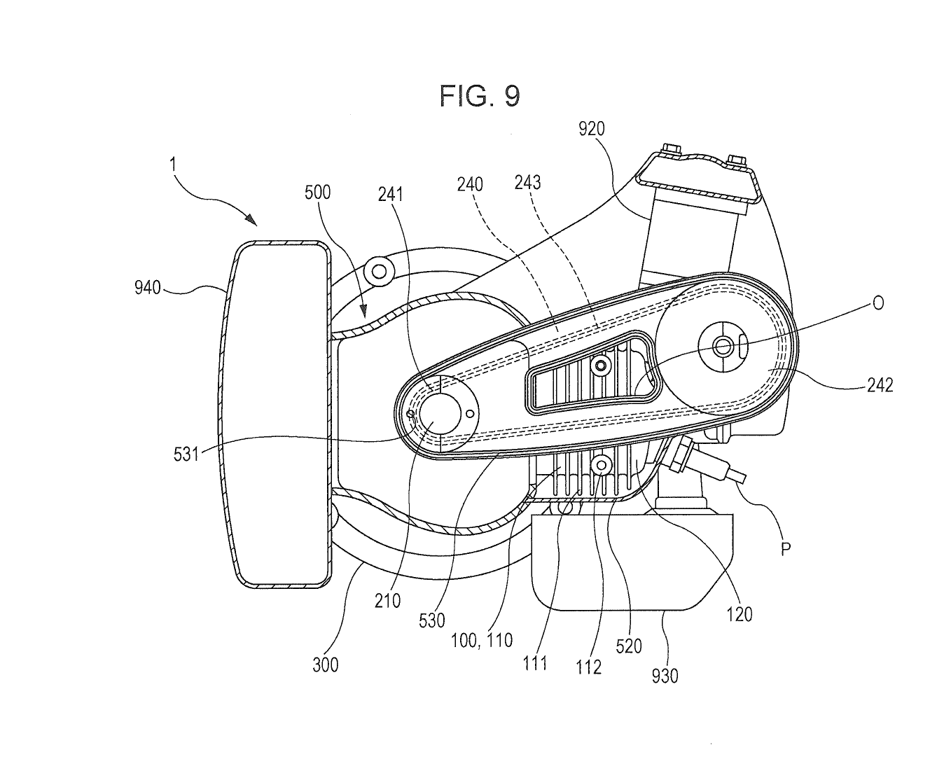

The belt housing 530 and a belt housing 620 of the lower blower housing 600 jointly form a belt housing in which the timing belt 243 is housed. FIG. 9 is a cross-sectional view of the engine 1 taken along line IX-IX of FIG. 1. As illustrated in FIG. 9, the timing belt 243 is housed in the belt housing along the entire circumference thereof, and an opening O, which allows cooling air to flow through, is formed in the middle of the timing belt 243. The belt housing 530 is disposed above the main body 510 and the cylinder cover 520, and is formed in an upwardly open tray shape by upwardly projecting the side wall from the outer circumferential edge of the bottom face which is formed in a substantially planar shape.

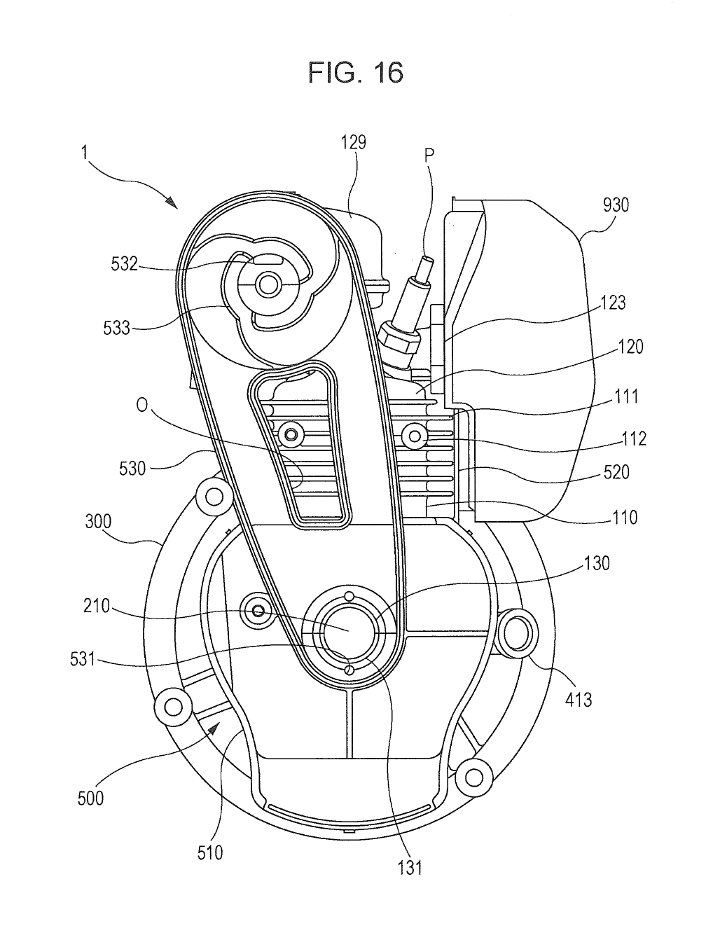

An opening 531 for introducing blow-by gas and oil from the passage 131a of the bearing cap 131 into the belt housing is formed at the upper main bearing 130 of the belt housing 530. An opening 532 (see FIG. 16), which allows oil to flow down into the cylinder head 120, is formed at the end of the belt housing 530 near the camshaft 126, the oil being separated from the blow-by gas in the belt housing. The opening 532 is provided, for instance, immediately above the area through which the sliding surface portion of the camshaft 126 passes, and oil may be dropped on the sliding portion between the sliding surface portion and the rocker arm.

As illustrated in FIG. 16, a guide surface portion 533 is formed around the opening 532 in order to collect oil in the opening 532 using the rotation of the cam sprocket 242. The guide surface portion 533 is formed in a spiral shape so as to gradually project to the inner radial side in the rotational direction of the cam sprocket 242 (clockwise direction in FIG. 16) from the outer circumferential surface (side wall) of the belt housing 530 to the circumference of the camshaft 126. In this example, for instance, three guide surface portions 533 are disposed away at substantially equal intervals around the rotational axis of the camshaft 126.

The lower blower housing 600 and the upper blower housing 700 jointly form a blower housing which is the space for housing the blower fan 260. The lower blower housing 600 and the upper blower housing 700 are integrally formed by injection molding respective resin-based materials.

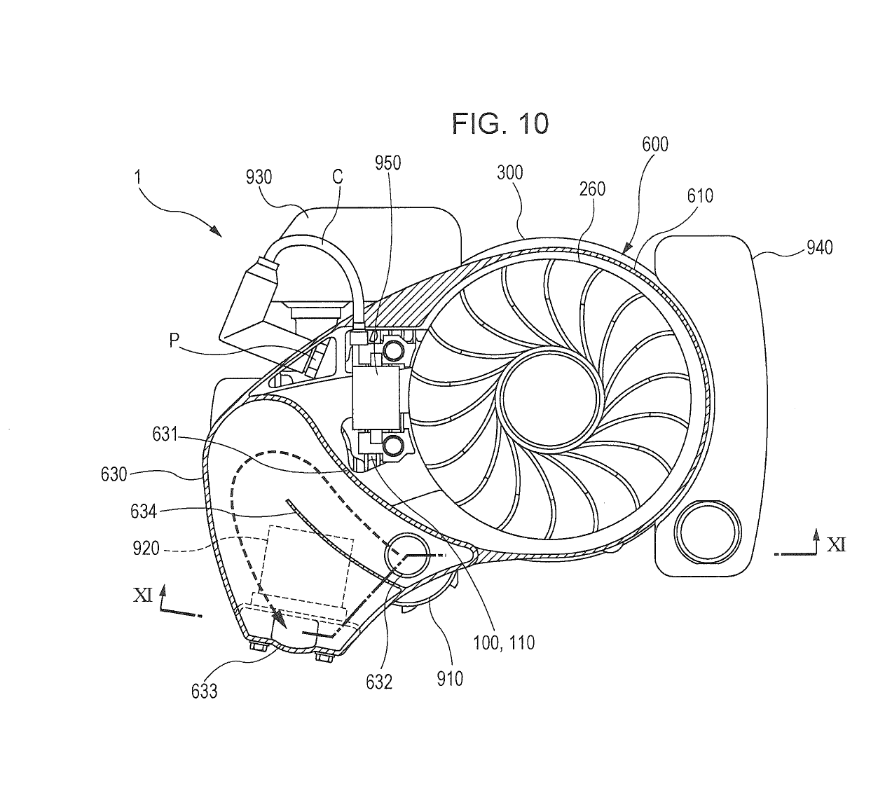

FIG. 10 is a top view (in the direction of the axis of the crankshaft) of the engine 1 after the upper blower housing 700, the recoil cover 800, and the recoil starter 270 are removed from the engine 1. The lower blower housing 600 includes a main body 610, the belt housing 620 (see FIG. 8), and an inlet chamber 630. The main body 610 constitutes the lower half of the space for housing the blower fan 260, and is formed in an upwardly open container shape by upwardly projecting the side wall from the outer circumferential edge of the bottom face which is formed in a substantially planar shape. As illustrated in FIG. 10, the main body 610 is formed in a circular shape which is substantially concentric with the crankshaft 210 and the blower fan 260 when seen in the axial direction of the crankshaft.

The belt housing 620 and the belt housing 530 of the upper crankcase 500 jointly form a belt housing which is substantially sealed. The belt housing 620 constitutes the upper half of the belt housing. The belt housing 620 is formed in a downwardly open container shape by downwardly projecting the side wall from the outer circumferential edge of the top face which is formed in a substantially planar shape. A groove is formed along substantially the entire circumference at the upper end of the belt housing 530, and a protrusion to be inserted into the groove is formed at the lower end of the belt housing 620. Similarly to the crankcase, the belt housings 530, 620 are connected to each other by filling the groove with adhesive having a sealing function and inserting and fitting the protrusion into the groove.

Immediately above the camshaft 126 in the belt housing 620, there is provided a communicating portion 621 (see FIG. 1) which separates gas from the liquid in the blow-by gas and oil mist in the belt housing using the centrifugal force due to the rotation of the cam sprocket 242 so as to introduce only the gas into the inlet chamber 630 of the blower housing. The communicating portion 621 is provided with a reed valve which prevents backward flow. An oil seal 622 for preventing leakage of oil from the belt housing to the blower housing is provided around an opening of the belt housing 620, the crankshaft 210 being inserted into the opening.

With the above configuration, during the operation of the engine 1, the blow-by gas accompanying the oil mist which exists in the crankcase is introduced into the belt housing via the passage 131a of the upper main bearing 130 and the opening 531 of the upper crankcase 500. The blow-by gas flows through the belt housing to reach the cam sprocket 242 where gas is separated from the liquid in the blow-by gas by the centrifugal force due to the rotation of the cam sprocket 242, and the blow-by gas is introduced into the below-described inlet chamber via the communicating portion 621 to be combusted in the engine 1. That is to say, the belt housing is used as a breather passage which discharges the blow-by gas in the crankcase in this example.

On the other hand, the oil separated from the blow-by gas flows down into the cylinder head 120 via the opening 532, and lubricates the sliding surface of the camshaft 126. The oil which has flown down to the bottom of the cylinder head 120 is returned back into the crankcase, for instance, by using a rubber hose H as illustrated in FIG. 1 or an oil passage 114 which is drilled and provided in the cylinder block 100 as illustrated in FIG. 5. The oil from the return opening near the crankcase is returned to the remaining oil in the crankcase, and thus backward flow of the blow-by gas is prevented.

The inside of the blower housing communicates with the inside of the cylinder cover 520 via a path between the outer circumferential edge of the belt housing 620 and the wall surface of the cylinder cover 520 and via the opening O which is formed in the middle of the belt housing. The cooling air generated by the blower fan 260 during the operation of the engine 1 flows through the above communicating path into the inside of the cylinder cover 520 as illustrated by dashed arrows in FIG. 8, and flows down around the cylinder 110 so as to pass through an interval between adjacent fins 111. In the above process, the belt housing is disposed away from the cylinder 110, and thus the cylinder 110 can be favorably cooled by the cooling air along the entire circumference of the cylinder 110. The cooling air after cooling the cylinder 110 is discharged from the opening 421 below the cylinder cover 420 to the outside of the engine 1.

The inlet chamber 630 and an inlet chamber 720 of the upper blower housing 700 jointly form an inlet chamber which is divided by partitions 631, 721 on the space for housing the blower fan 260, and serves as part of the inlet passage. The inlet chamber is formed in a container shape vertically divided in two halves by the inlet chambers 630, 720. The inlet chamber serves as a resonator having a large capacity which is disposed between the air cleaner 910 and the carburetor 920, and thus an effect is obtained in that intake noise is reduced and the charging efficiency of the engine 1 is improved by resonance supercharging.

As illustrated in FIG. 10, the inlet chamber 630 includes a partition 631, an air cleaner communicating portion 632, a carburetor communicating portion 633, and a partition 634. The inlet chamber 630 is disposed at the upper circumference of the cylinder head 120. The partition 631 sets the divided main body 610 (the space for housing the blower fan 260) in the lower blower housing 600.

The air cleaner communicating portion 632 is a component to which the air cleaner 910 is connected, and into which air filtered by the air cleaner 910 is introduced. The air cleaner communicating portion 632 has a conduit line which projects downward from the bottom surface (lower surface) of the inlet chamber 630 adjacent to the space for housing the blower fan 260. The outlet of the air cleaner 910 is connected to the conduit line.

The carburetor communicating portion 633 is a component to which the carburetor 920 is connected, and through which air which has passed through the inlet chamber is introduced into the carburetor 920. The carburetor communicating portion 633 has a conduit line which projects downward from the bottom surface (lower surface) of the inlet chamber 630 adjacent to the air cleaner communicating portion 632. The lower end (outlet) of the conduit line is connected to the inlet of the barrel of the carburetor 920.

The partition 634 stands up from the bottom surface of the inlet chamber 630, and, as illustrated in FIG. 10, extends from the side wall between the air cleaner communicating portion 632 and the carburetor communicating portion 633 to the center of the inlet chamber 630 when the engine 1 is viewed from the top.

The upper blower housing 700 includes a main body 710 and the inlet chamber 720. The main body 710 constitutes the upper half of the space for housing the blower fan 260, and is formed in a downwardly open container shape. The lower end of the side wall of the main body 710 is connected to the upper end of the side wall of the lower blower housing 600. An opening 711 used for mounting the recoil starter 270 is formed at the upper surface of the main body 710.

The inlet chamber 720 and the inlet chamber 630 of the lower blower housing 600 jointly form an inlet chamber. The inlet chamber 720 is divided from the main body 710 by the partition 721. The partition 721 is formed to project downward from the upper surface of the upper blower housing 700, and the lower end thereof is connected to the upper end of partition 631 of the lower blower housing 600.

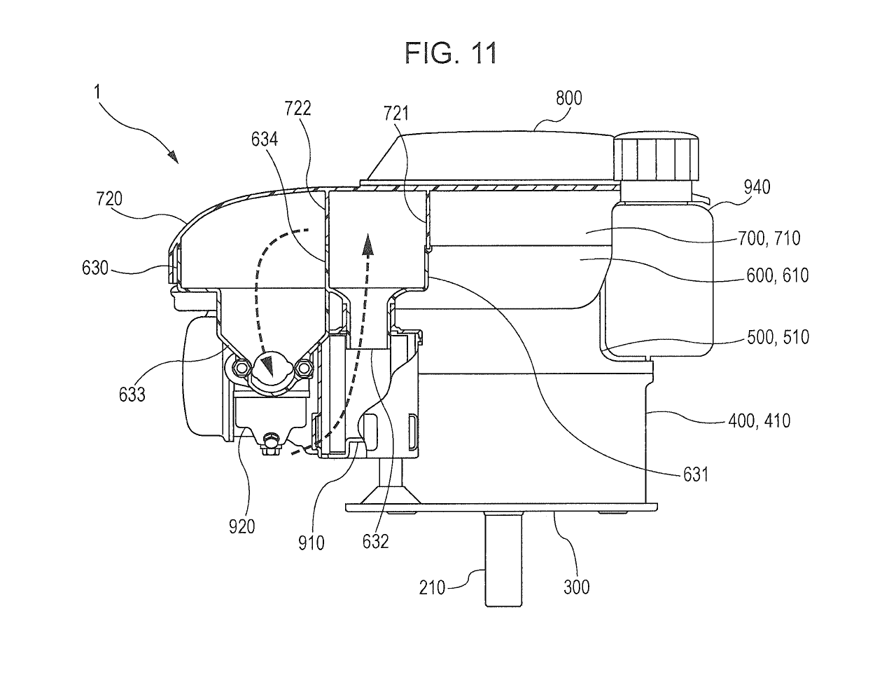

The inlet chamber 720 is formed to project downward from the upper surface, and the lower end thereof is provided with a partition 722 (see FIG. 11) which is connected to the partition 634. By providing such partitions 634, 722, the outlet of the air cleaner communicating portion 632 and the inlet of the carburetor communicating portion 633 are blocked from each other in the inlet chamber, and thus the noise radiated from the inlet of the carburetor 920 is prevented from transmitting to the air cleaner 910 directly and discharging to the outside. In addition, as illustrated by a dashed arrow in FIG. 10, air is made to flow in U-turn bypassing the partition 634 and a substantial length of passage in the inlet chamber 720 is ensured, and thus the charging efficiency of the engine 1 can be improved using a ripple and improvement of the output can be achieved. It is to be noted that the side walls of the inlet chambers 630, 720 are formed in a concave curved surface shape substantially in a turning direction of the air flow in order to reduce turbulence and pressure loss of the air flow in U-turn bypassing the partition 634.

The recoil cover 800 is a member which is arranged from the top on the opening 711 of the upper blower housing 700 so as to cover components including the recoil starter 270. As illustrated in FIG. 20, a great number of openings for introducing cooling air are formed in the recoil cover 800 and the upper surface of the main body 710 of the upper blower housing 700.

The air cleaner 910 introduces outside air for filtering and removing foreign substances such as dust, and further introduces the air into the inlet chambers in the blower housing. The air cleaner 910 is formed in, for instance, concentrically arranged double tube shape, and the outside air introduced from a slit formed on the outer circumferential surface of the outer tube is filtered by a filter element disposed between the inner and outer tubes, and the filtered air is introduced radially inward of the inner tube. The tube axis of the air cleaner 910 is disposed substantially parallel to the rotational axis of the crankshaft 210, and is arranged under the bottom surface of the inlet chamber 630 of the lower blower housing 600. The inner tube of the air cleaner 910 is connected to the air cleaner communicating portion 632.

The carburetor 920 is connected to the inlet port 122 of the cylinder head 120 to generate a fuel-air mixture by creating a fuel spray by a venturi action where the carburetor 920 is provided with a throttle in the middle of the barrel which introduces air for combustion (clean air). The carburetor 920 includes a throttle valve for adjusting an output of the engine, and a choke valve for chalking in the case of cold start. The carburetor 920 is mounted on the inlet of the inlet port 122 of the cylinder head 120 with a heat insulator made of resin, for instance, being interposed between the carburetor 920 and the inlet.

The muffler 930 reduces exhaust energy of the engine 1 to control noise. The muffler 930 is connected to the outlet of the exhaust port 123 of the cylinder head 120.

The fuel tank 940 is a container which stores the fuel of the engine 1, for instance, gasoline. The fuel tank 940 is disposed adjacent to the lateral surface of the crankcase.

The ignition device 950 supplies pulse-like electric power to a spark plug via a plug cord at a predetermined ignition timing so as to ignite the spark plug. The ignition device 950 is housed in the blower housing, and is secured using a bolt or the like to the ignition device mounting portion 112 which stands up from the cylinder 110.

The drive control mechanism 960 drives the throttle valve and the choke valve of the carburetor 920 in coordination with the governor mechanism 250 according to an input from a throttle operation unit and a choke operation unit which are operated by a user, thereby controlling the output and number of revolutions of the engine 1.

Next, a method of assembling the engine according to the above-described example will be described. First, the cylinder block 100 which has undergone a predetermined machining process is prepared. The small end of the conn-rod 230 is inserted into the piston 220 so as to pass through the piston pin. The conn-rod 230 is rockably connected to the piston 220 so as to insert the piston 220 into the cylinder 110. In the above process, the piston ring and the oil ring are pre-assembled into the ring groove which is formed on the outer circumferential surface of the piston 220. The inlet valve 124 and the exhaust valve 125 are inserted from the inside of the cylinder into each valve stem guide, and the valve springs 124a, 125a and a retainer are mounted.

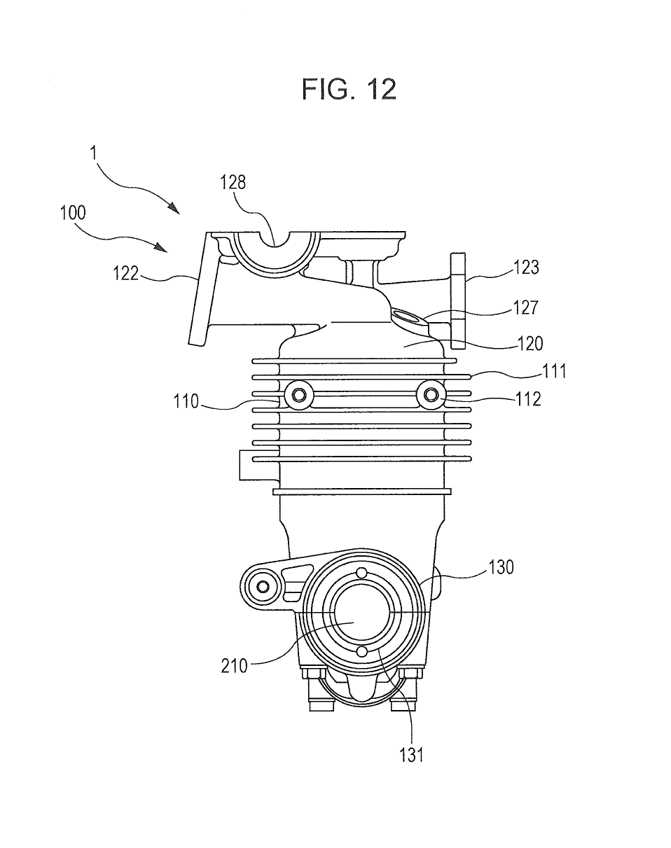

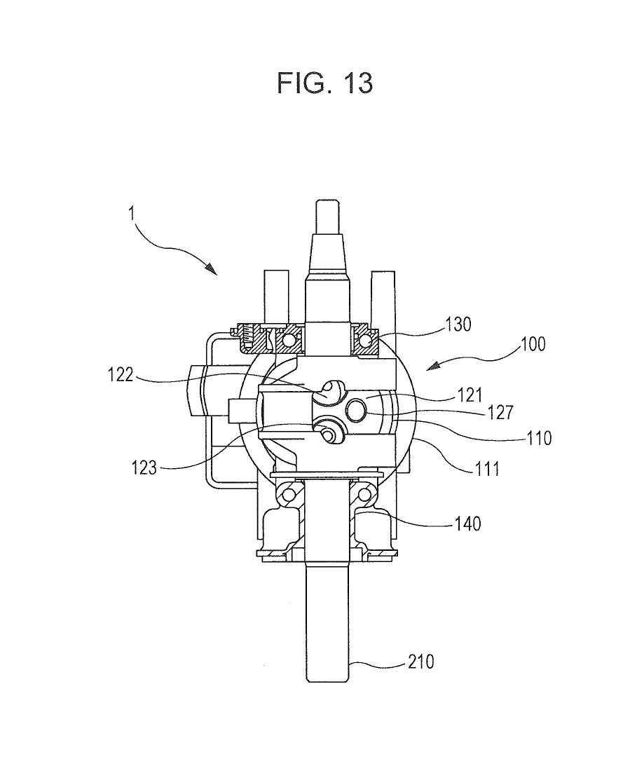

Subsequently, the large end of the conn-rod 230 is rockably connected to the crankpin of the crankshaft 210, which is mounted on the upper main bearing 130 and the lower main bearing 140. FIG. 12 is a top view of the engine 1 (cylinder block 100) immediately after the crankshaft is mounted. FIG. 13 is a schematic cross-sectional view of the engine 1 (cylinder block 100) taken along a plane which is perpendicular to the axial direction of the cylinder and includes the axis of the crankshaft immediately after the crankshaft is mounted. In FIG. 13, the piston 220, the conn-rod 230, the inlet valve 124, and the exhaust valve 125 are not illustrated.

Subsequently, the oil seal 142 and the governor mechanism 250 are mounted on the lower main bearing 140 of the cylinder block 100, and the base plate 300 and the lower crankcase 400 are further mounted. The circumferential area of the opening 412 in the main body 410 of the lower crankcase 400 is interposed between the lower main bearing 140 and the base plate 300. In the above process, in order to improve sealing performance, the groove of the lower main bearing 140 is filled with adhesive having a sealing function. After the protrusion of the lower crankcase 400 is inserted, adhesive overflowing from the groove seals the connecting surface between the lower main bearing 140 and the circumferential edge of the opening 412 so as to prevent leakage of oil.

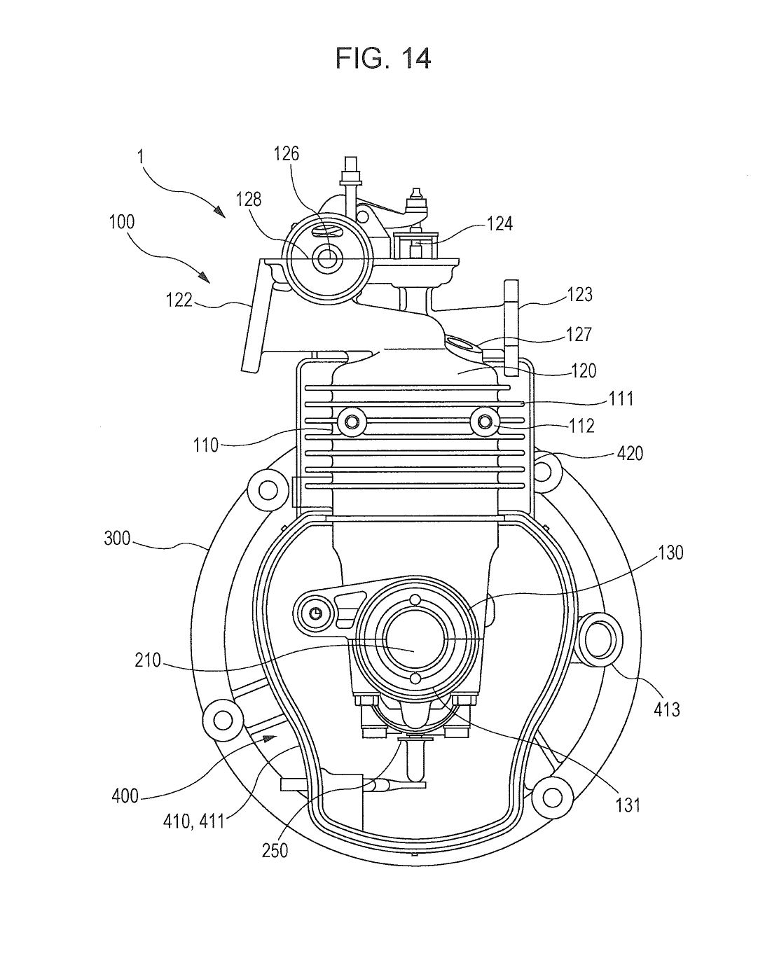

In addition, variable valve drive mechanisms such as the camshaft 126, a tappet, and a rocker arm are mounted on the cylinder head 120. FIG. 14 is a top view of the engine 1 after the lower crankcase 400 and others are mounted. FIG. 15 is a schematic cross-sectional view of the engine 1 taken along a plane which is perpendicular to the axial direction of the cylinder and includes the axis of the crankshaft immediately after the lower crankcase 400 and others are mounted.

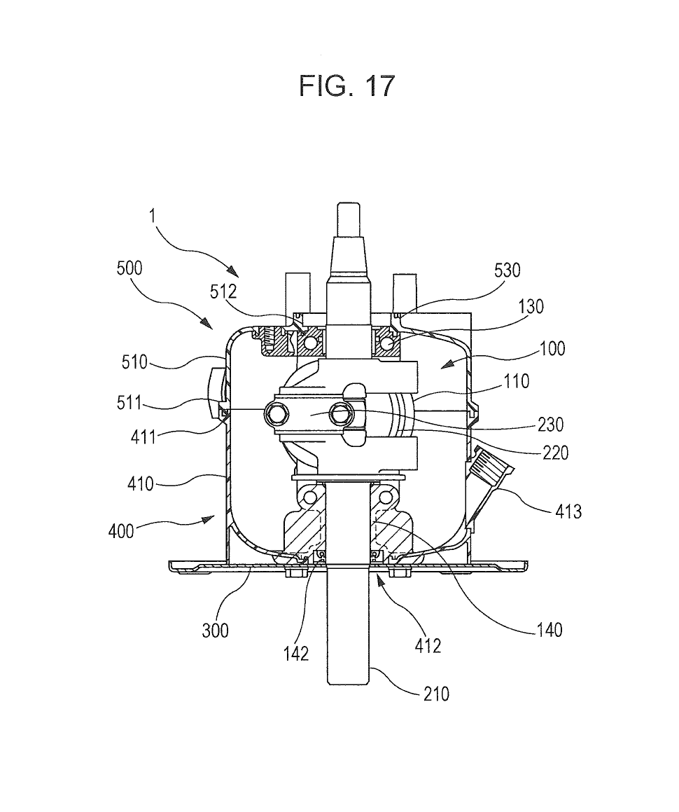

Subsequently, the upper crankcase 500 is mounted above the lower crankcase 400. In the above process, the groove in the upper edge 411 of the main body 410 of the lower crankcase 400 is filled with an adhesive as described above, the protrusion of the lower edge 511 of the main body 510 of the upper crankcase 500 is inserted into and fitted to the groove, thereby firmly connecting the protrusion and the groove along the entire circumference. Similarly, the upper main bearing 130 and the upper portion of the main body 510 are also connected to each other by fitting and bonding between the protrusion and the groove. FIG. 16 is a top view of the engine 1 after the upper crankcase 500 and others are mounted. FIG. 17 is a schematic cross-sectional view of the engine 1 taken along a plane which is perpendicular to the axial direction of the cylinder and includes the axis of the crankshaft after the upper crankcase 500 and others are mounted.

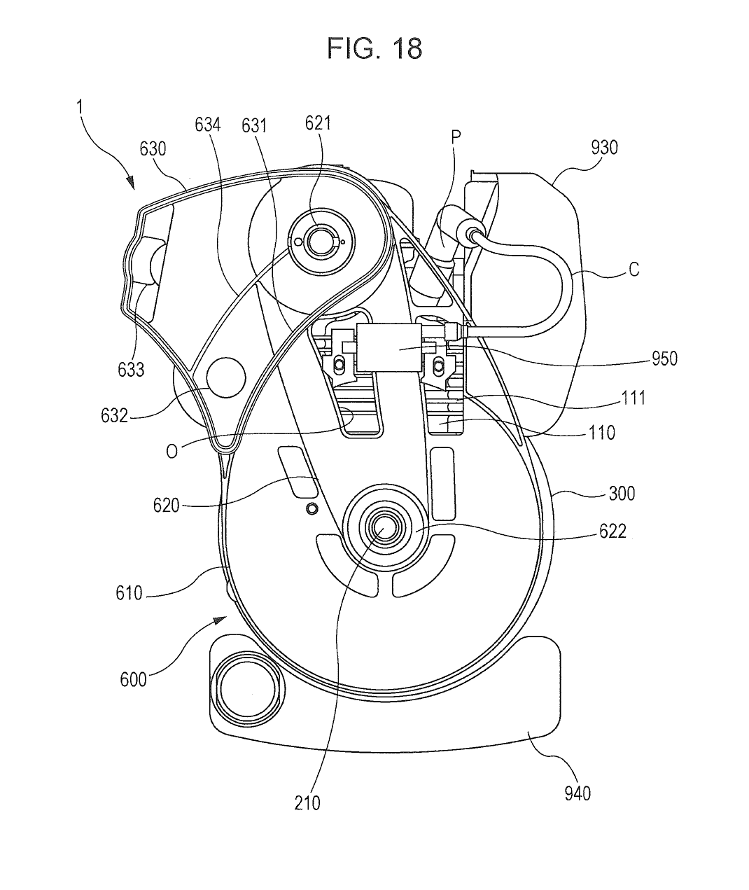

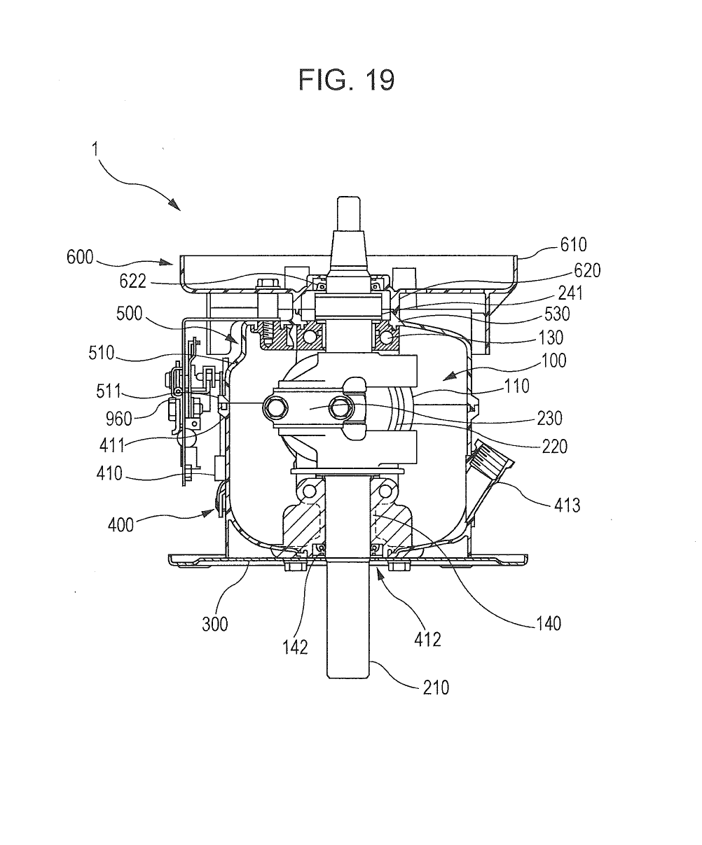

Subsequently, the crank sprocket 241, the cam sprocket 242, the timing belt 243, and the drive control mechanism 960 are mounted, and then the lower blower housing 600 is mounted. Subsequently, the ignition device 950, the spark plug P, the plug cord C, and the fuel tank 940 are mounted. FIG. 18 is a top view of the engine 1 after the lower blower housing 600 and others are mounted. FIG. 19 is a schematic cross-sectional view of the engine 1 taken along a plane which is perpendicular to the axial direction of the cylinder and includes the axis of the crankshaft after the lower blower housing 600 and others are mounted.

Next, the blower fan 260 is fixed to the crankshaft 210, and the upper blower housing 700 is mounted above the lower blower housing 600. Subsequently, the recoil starter 270 and the recoil cover 800 are mounted, and the oil level gauge G is inserted to complete the engine 1. FIG. 20 is a top view of the completely assembled engine 1. FIG. 21 is a schematic cross-sectional view of the completely assembled engine 1 taken along a plane which is perpendicular to the axial direction of the cylinder and includes the axis of the crankshaft.

As described above, in this example, the cylinder block 100, which incorporates the main mechanisms, may be assembled by stacking each member one by one from bottom to top, and thus the assembly process is simplified. Large components such as the lower crankcase 400, the upper crankcase 500, the lower blower housing 600, the upper blower housing 700, and the recoil cover 800 may be formed as an integrally molded workpiece made of resin. Connection between these components is made by fitting and bonding the protrusions to respective grooves, and thus a high strength of connection and product rigidity can be obtained by simple work process. In addition, space for connection and work space for using tools do not need to be considered because a fastener such as a bolt is not used for connecting these resin components, and thus design flexibility is improved and the weight of product is reduced.

As described above, the following effects can be obtained in this example.
(1) The crankcase can be a resin molded component rather than a typical metal cast component, and thus a significant decrease in weight and reduction in cost can be achieved. Furthermore, radiated noise from the crankcase can be also reduced. The lower crankcase 400 and the upper crankcase 500 are connected to each other by fitting and bonding, and thus a fastener such as a bolt does not need to be provided in order to connect these members. Furthermore, an assembly space for screwing bolts, and a work space for using tools or allowing a worker's hands do not need to be considered, and thus reduction in weight, a simplified structure, an improvement in design flexibility, and a simplified manufacturing process can be achieved. In addition, the lower crankcase 400 and the upper crankcase 500 member are continuously connected along substantially an entire length, and thus, a high strength of connection, rigidity of the crankcase, and a favorable sealing function for reliably sealing against lubricating oil or blow-by gas leakage can be obtained.
(2) The lower crankcase 400 and the upper crankcase 500 can be easily and firmly fixed to each other by fitting the protrusion to the groove for connection. In addition, it is also easy to reliably seal the connecting portion by previously filling the groove with an adhesive or a sealing agent.
(3) The connecting portions between the upper main bearing 130 and the upper crankcase 500, and between the lower main bearing 140 and the lower crankcase 400 can be easily and firmly fixed to each other by fitting and bonding the respective protrusions to the corresponding grooves for connection, and a favorable sealing function can be obtained. According to this, the above connecting portions can be easily and firmly fixed to each other, and a favorable sealing function can be obtained.
(4) By providing the cylinder covers 420, 520 which are respectively integrally formed with the lower crankcase 400 and the upper crankcase 500, the cooling efficiency of the cylinder 110 can be increased and emission of radiated noise from the cylinder 110 to the outside can be reduced, and thus further reduction of noise can be achieved.
(5) Part and the remaining part of the belt housing are respectively integrally formed with the upper crankcase 500 and the lower blower housing 600, and thus a simplified structure, reduction in the number of components, and decrease in weight and cost can be achieved.
(6) The belt housing is disposed away from the cylinder 110, and cooling air is allowed to pass through the opening 0 which is formed in the middle of the belt housing, and thus the entire circumference of the cylinder 110 can be favorably cooled.
(7) The cylinder 110, the cylinder head 120, the upper main bearing 130, and the lower main bearing 140 are integrally formed, and thus a simplified structure, reduction in the number of components, and decrease in weight and cost can be achieved.

### [Modification]

The present invention is not limited to the example described above, and various modifications and changes may be made, which are also included in the technical scope of the present invention. The shape, structure, material, and manufacturing process of each member included in the engine are not limited to those in the above-described example, and may be changed as appropriately. For instance, in this example, the crankcase, the belt housing, and the blower housing are divided in halves in the crankshaft direction, however, the manner of division and the number of division are not particularly limited. The engine according to the example is so-called a V-type engine, in which the crankshaft is vertically disposed, however, the present invention is not limited to this, and may be applied to an engine which is horizontally disposed. In the engine according to the example, connecting portions of the members are connected by fitting and bonding between the protrusion and the groove, however, without being limited to this, connection may be made by welding, for instance. When a sufficient sealing performance is obtained only by fitting, bonding and welding may not be performed. The engine according to the example uses a timing belt as a member for transmitting power from the crank sprocket to the cam sprocket, however, the engine may use a timing chain alternatively.

1. An engine comprising:
a cylinder;
a first bearing at least partially integrally formed with the cylinder and configured to rotatably support a first shaft of a crankshaft;
a second bearing at least partially integrally formed with the cylinder and configured to rotatably support a second shaft of the crankshaft; and
a first crankcase member and a second crankcase member including a resin-based material, and respectively constituting part and remaining part of a crankcase housing the crankshaft,
wherein a connecting portion between the first crankcase member and the second crankcase member is continuously connected along substantially an entire length by at least one of fitting, bonding, and welding.

2. The engine according to claim 1,
wherein a protrusion is formed in the connecting portion of the first crankcase member to be connected with the second crankcase member, and
a groove is formed in the connecting portion of the second crankcase member to be connected with the first crankcase member, the protrusion being inserted and fitted into the groove.

3. The engine according to claim 1,
wherein the crankshaft is divided into the first crankcase member and the second crankcase member in an axial direction of the crankshaft,
the first crankcase member has a first opening on which the first bearing is mounted,
the second crankcase member has a second opening on which the second bearing is mounted, and
a connecting portion between a circumferential edge of the first opening and the first bearing, and a connecting portion between a circumferential edge of the second opening and the second bearing are each continuously connected along substantially an entire length by at least one of fitting, bonding, and welding.

4. The engine according to claim 2,
wherein the crankshaft is divided into the first crankcase member and the second crankcase member in an axial direction of the crankshaft,
the first crankcase member has a first opening on which the first bearing is mounted,
the second crankcase member has a second opening on which the second bearing is mounted, and
a connecting portion between a circumferential edge of the first opening and the first bearing, and a connecting portion between a circumferential edge of the second opening and the second bearing are each continuously connected along substantially an entire length by at least one of fitting, bonding, and welding.

5. The engine according to claim 1,
wherein at least one of the first crankcase member and the second crankcase member is integrally formed and has a cylinder cover for covering a circumference of the cylinder and guiding cooling air to be introduced to an inside.

6. The engine according to claim 2,
wherein at least one of the first crankcase member and the second crankcase member is integrally formed and has a cylinder cover for covering a circumference of the cylinder and guiding cooling air to be introduced to an inside.

7. The engine according to claim 3,
wherein at least one of the first crankcase member and the second crankcase member is integrally formed and has a cylinder cover for covering a circumference of the cylinder and guiding cooling air to be introduced to an inside.

8. The engine according to claim 4,
wherein at least one of the first crankcase member and the second crankcase member is integrally formed and has a cylinder cover for covering a circumference of the cylinder and guiding cooling air to be introduced to an inside.

9. The engine according to claim 1,
wherein part of a power transmission member housing is integrally formed with at least one of the first crankcase member and the second crankcase member, the power transmission member housing being configured to house a power transmission member which transmits power from the crankshaft to a camshaft.

10. The engine according to claim 2,
wherein part of a power transmission member housing is integrally formed with at least one of the first crankcase member and the second crankcase member, the power transmission member housing being configured to house a power transmission member which transmits power from the crankshaft to a camshaft.

11. The engine according to claim 3,
wherein part of a power transmission member housing is integrally formed with at least one of the first crankcase member and the second crankcase member, the power transmission member housing being configured to house a power transmission member which transmits power from the crankshaft to a camshaft.

12. The engine according to claim 4,
wherein part of a power transmission member housing is integrally formed with at least one of the first crankcase member and the second crankcase member, the power transmission member housing being configured to house a power transmission member which transmits power from the crankshaft to a camshaft.

13. The engine according to claim 9,
wherein a remaining part of the power transmission member housing is integrally formed with part of a blower housing which is fixed to the crankshaft and houses a blower fan for generating cooling air when in rotation.

14. The engine according to claim 10,
wherein a remaining part of the power transmission member housing is integrally formed with part of a blower housing which is fixed to the crankshaft and houses a blower fan for generating cooling air when in rotation.

15. The engine according to claim 11,
wherein a remaining part of the power transmission member housing is integrally formed with part of a blower housing which is fixed to the crankshaft and houses a blower fan for generating cooling air when in rotation.

16. The engine according to claim 12,
wherein a remaining part of the power transmission member housing is integrally formed with part of a blower housing which is fixed to the crankshaft and houses a blower fan for generating cooling air when in rotation.

17. The engine according to claim 1,
wherein the cylinder and a cylinder head are integrally formed, the cylinder head having inlet and exhaust ports and being provided at an end of the cylinder that is opposite to an end of the crankshaft of the cylinder.

18. The engine according to claim 2,
wherein the cylinder and a cylinder head are integrally formed, the cylinder head having inlet and exhaust ports and being provided at an end of the cylinder that is opposite to an end of the crankshaft of the cylinder.

19. The engine according to claim 3,
wherein the cylinder and a cylinder head are integrally formed, the cylinder head having inlet and exhaust ports and being provided at an end of the cylinder that is opposite to an end of the crankshaft of the cylinder.

20. The engine according to claim 4,
wherein the cylinder and a cylinder head are integrally formed, the cylinder head having inlet and exhaust ports and being provided at an end of the cylinder that is opposite to an end of the crankshaft of the cylinder.
